(19) United States
(12) Patent Application Publication
(10) Pub. No.: US 2003/0004301 A1
(43) Pub. Date: Jan. 2, 2003

(54) Method of spinning, spooling, and stretch texturing polyester filaments and polyester filaments thereby produced

(76) Inventors: Dietmar Wandel, Hanau (DE); Achim Dulling, Koln (DE); Ulrich Mirwaldt, Maintal (DE); Alexander Klein, Ingelheim (DE)

Correspondence Address: Michael S. Greenfield, McDonnell Boehnen Hulbert & Berghoff, 32nd Floor, 300 S. Wacker Drive, Chicago, IL, 60606, US

(21) Appl. No.: 10/179,697

(22) Filed: Jun. 25, 2002

Related U.S. Application Data
(63) Continuation-in-part of application No. 10/000,288, filed on Nov. 2, 2001.
(60) Provisional application No. 60/263,013, filed on Jan. 19, 2001.

(30) Foreign Application Priority Data
Nov. 3, 2000 (DE) 100 54 422.3-26

(51) Int. Cl. D02G 3/00; C08G 63/02

(52) U.S. Cl. 528/272; 428/364

(57) ABSTRACT

The present invention comprises a process for producing and spooling preoriented polyester filaments comprising at least 90 weight % (relative to the total weight of the polyester filaments) polybutylene terephthalate (PBT) and/or polytrimethylene terephthalate (PTMT), preferably of PTMT, wherein,

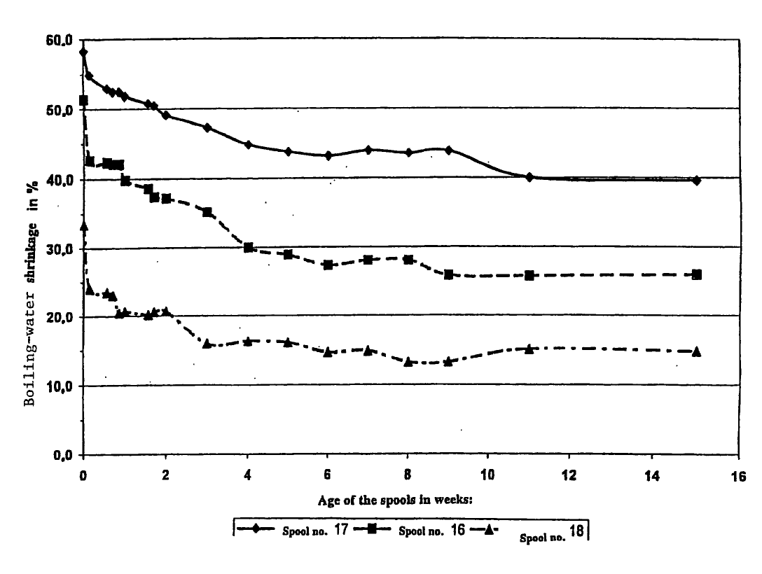

a) the spinline extension-ratio is set in the range of 70 to 500;

b) the filaments, immediately after exiting from the spinning nozzles, pass through a cooling delay zone from 30 mm to 200 mm in length;

c) the filaments are cooled off to below the solidification temperature;

d) the filaments are bundled at a distance of between 500 mm and 2500 mm from the lower side of the spinneret plate;

e) the tension of the thread in front of and between the draw-off galettes is set to between 0.05 cN/dtex to 0.20 cN/dtex;

f) the thread is spooled with a tension of the thread of between 0.025 cN/dtex to 0.15 cN/dtex;

g) the spooling speed is adjusted to between 2200 m/min. and 6000 m/min.;

h) and from 0.05 weight % to 2.5 weight % (relative to the total weight of the filament) of an additive polymer is mixed as a filament elongation-enhancing agent.

This application claims the benefit of U.S. Provisional Application No. 60/263,013, filed Jan. 19, 2001.

### BACKGROUND OF THE INVENTION

1. Field of the Invention

The present invention relates to a process for the spinning and spooling of preoriented polyester filaments using spinning additives, which filaments comprise (in the amount of at least 90 weight % in relation to the total weight of the polyester filament) polybutylene terephthalate (PBT) and/or polytrimethylene terephthalate (PTMT), preferably of PTMT, as well as the preoriented polyester filaments obtained by the process. In addition, the present invention relates to a process for the stretch texturing of the spun and spooled polyester filaments, as well as the bulky polyester filaments obtained by means of stretch texturing.

2. Summary of the Related Art

The production of continuous polyester filaments in a two-stage process, particularly polyethylene terephthalate (PET) filaments, is known. In this process, flat, preoriented filaments are spun and spooled during a first stage and then, during a second stage, stretched into finished form and thermofixed, or else stretch-textured into bulky filaments.

The book “Synthetic Fibers” by F. Fourné (1995), published by Hanser-Verlag, Munich, provides an overview of this. Only the production of PET fibers is described by Fourné, and no closed spinning technology is explained but, instead, this is only an overview in which the most general characteristics are described.

The technical production of various spinable polymers, such as polypropylene, polyamides, polyesters, among others, is the object of application document DE-OS 38 19 913. Only the production of PET fibers is described in the examples, as it can be derived at the temperature at which the polymer is processed,.

In the production of continuous polytrimethylene terephthalate (PTMT) or polybutylene terephthalate (PBT) filaments, the problem exists that preoriented filaments have a considerable tendency to shrink during storage at ambient temperature, both immediately after the spinning and upon the spooling, as well as several hours after the spooling, leading to a shortening of the fibers. The bobbin is thereby compressed so that, in the extreme case, a tight shrinking of the bobbin on the spooling chuck arises, and the bobbin can no longer be removed. Furthermore, a so-called saddle with hard edges and an indented middle part forms the bobbin. By that means, the characteristic textile values of the filaments, such as the uster, for example, become unevenly stronger, and there are unspooling problems during the processing of the bobbins. Such types of problems do not appear during the processing of PET fibers.

Furthermore, it has been observed that, in contrast to PET filament, preoriented PBT and PTMT filaments show increased signs of aging during storage. A structural hardening appears, which leads to such a great reduction of the filament shrinkage that a subsequent crystallization can be observed. Such types of PBT and PTMT filaments are only conditionally suitable for further processing and lead to errors in the stretch texturing as well as to a significant reduction of the tenacity of the textured thread.

These differences between PET on the one hand and PBT and PTMT on the other are attributable to differences in structures and properties such as are presented, for example, in Chemical Fibers Int., page 53, volume 50 (2000) and were the theme of the 39th Int. Man-Made Fibers Congress, from Sep. 13 to 15, 2000, in Dornbrn. It is thus assumed that different chain formations are responsible for the differences in properties.

First attempts to solve these problems were described in the patent application WO 99/27168 and the European patent EP 0 731 196 B1. WO 99/27618 discloses a polyester fiber which consists of at least 90 weight % of polytrimethylene terephthalate and has a boiling-water shrinkage of between 5% and 16%, as well as an elongation of 20% to 60%. The production of the polyester fibers described in WO 99/27168 is carried out by means of spinning and stretching. In this, spinning speeds of a maximum of 2100 m/min. are stated. The process is uneconomical because of the low spinning speed. Furthermore, the polyester fibers that are obtained are, as the characteristic constants indicated show, strongly crystalline and, consequently, are suitable for stretch texturing processes only to limited degree.

European patent EP 0 731 196 B1 claims a process for spinning, stretching, and spooling of synthetic thread in which the thread is, after the stretching but before the spooling, subjected to heat treatment to reduce the tendency to shrink. Usable synthetic fibers also include polytrimethylene terephthalate fibers. In accordance with EP 0 731 196 B1, the heat treatment takes place by closely guiding the synthetic thread (essentially without contact) along a longitudinally extended heating surface. The use of a heat treatment makes the process more expensive and additionally results in synthetic threads with high crystallinity. Such threads are suitable for stretch texturing only to a limited extent.

Stretch texturing of preoriented polytrimethylene terephthalate filaments at texturing speeds of 450 m/min. and 850 m/min. is described in the article by Dr. H. S. Brown and H. H. Chuah, “Texturing of textile filament yarns based on polytrimethylene terephthalate” in Chemical Fibers International, Volume 47, February 1997, pages 72-74. According to this disclosure, the lower texturing speed of 450 m/min. is better suited for polytrimethylene terephthalate filaments since fibers with better material properties are obtained. The tenacity of the polytrimethylene terephthalate fibers is stated as 26.5 cN/tex (texturing speed of 450 m/min.) or 29.15 cN/tex (texturing speed of 850 m/min.), respectively, and the elongation at 38.0% (texturing speed of 450 m/min.) or 33.5% (texturing speed of 850 m/min.), respectively.

WO 01/04393 describes PTMT filaments having a shrinkage in the range of 3 to 40%. This value is determined immediately after the production of the filaments, however. As the appended FIGURE shows, this value drops to below 20% under normal conditions after a storage time of 4 weeks.

The shrinkage is a measure of the processability and degree of crystallization of the fibers. The fibers described in WO 01/04393 have a higher degree of crystallization. The processing of such fibers is significantly worse and only at lower stretching ratios and/or lower texturing speeds.

### SUMMARY OF THE INVENTION

The present invention provides a process for spinning and spooling preoriented polyester filaments that comprise, by at least 90 weight % in relation to the total weight of the filaments, PBT and/or PTMT, which process simplifies the production and the spooling of preoriented polyester filaments. In particular, the preoriented polyester filaments produced by the process of the invention have values for elongation at break in the range of 90% to 165%, a high uniformity of the characteristic filament values, as well as a low degree of crystallization.

The process of the invention for spinning and spooling preoriented polyester filaments can be carried out on a large technical scale and in an economical manner. The process in accordance with the invention permits the highest possible spinning speeds, preferably greater than 2200 m/min., and high thread weights, of more than 4 kg, of the bobbin.

The process of the present invention improves the storability of the preoriented polyester filaments thereby produced. These preoriented polyester filaments can be stored for a longer period of time than prior art filaments (e.g., 4 weeks). Compression of the bobbin during storage, particularly a tight shrinking of the bobbin onto the spooling chuck, as well as the formation of a saddle with hard edges and indented middle part, is prevented, to the extent possible, so that no unspooling problems occur during the processing of the bobbins.

In accordance with the invention, the preoriented polyester filaments can be further processed in a simple way in a stretch or stretch texturing process, particularly at high texturing speeds, preferably greater than 450 m/min. The filaments obtained by means of stretch texturing have outstanding material properties, such as a high tenacity at break of more than 26 cN/tex, for example, as well as a high elongation at break of more than 30% in the case of HE-filaments, or more than 36% for SET filaments.

All patents, patent applications, and other publications recited herein are incorporated by reference in their entirety. In the event of an inconsistency between the present disclosure and the disclosures incorporated by reference, the present disclosure is relied upon herein.

### BRIEF DESCRIPTION OF THE DRAWING

The FIGURE describes the change of the boiling-water shrinkage for three PTMT-POY bobbins in dependence on the storage time under normal climate conditions. In this, the change of the POY shrinkage was investigated for three bobbins with different starting values over the storage time at normal climate conditions. Spools no. 16 and 17, with a high initial value >40%, show, after 4 weeks, a shrinkage above 30%, preferably above 40%. In the event that the initial value of the boiling-water shrinkage is lower than 40%, however, then bobbin 18 shows that this drops below the critical value of 30% after 4 weeks of storage time.

### DETAILED DESCRIPTION OF THE INVENTION

The present invention comprises a process for producing and spooling preoriented polyester filaments that comprise polybutylene terephthalate (PBT) and/or polytrimethylene terephthalate (PTMT) (preferably of PTMT) in an amount that is at least 90 weight % in relation to the total weight of the polyester filaments, the process comprising:

a) spinning the filaments through spinning nozzles with a spinline extension ratio in the range of 70 to 500;

b) passing the filaments, immediately after exiting from the spinning nozzles, through a cooling delay zone from 30 mm to 200 mm in length;

c) cooling the filaments to below the PBT or PTMT solidification temperature;

d) bundling the filaments at a distance of between 500 mm and 2500 mm from the lower side of the spinneret plate;

e) setting the tension of the thread in front of and between draw-off galettes to between 0.05 cN/dtex to 0.20 cN/dtex;

f) spooling the thread with a tension of between 0.025 cN/dtex to 0.15 cN/dtex and spooling speed of between 2200 m/min. and 6000 m/min.;

h) mixing in a polyester a filament elongation-enhancing agent in an amount of 0.05 weight % to 2.5 weight % (in relation to the total weight of the filament of additive polymer).

With the process of the present invention we have been able, in a manner that was simply not foreseeable, to make polyester filaments with outstanding properties, even after a storage for 4 weeks under normal conditions. No significant worsening of the uniformity values of the thread resulting from aging or shrinking of the spun fiber bobbin is observed.

The process in accordance with possesses, at the same time, a series of additional advantages. These include, among others, the following:

The process in accordance with the invention can be conducted simply, on a large scale, and economically. In particular, the process permits spinning and spooling at high spooling speeds of at least 2200 m/min., as well as production of high thread weights (of more than 4 kg) of bobbins.

Through the use of spinning additives, speeds of up to 6000 m/min. can be achieved. Because of this, the equipment can be operated in a particularly economic manner.

The preoriented polyester filaments obtained by means of the process consequently can be further processed simply, on a large scale, and in an economical manner, in either a stretch or a stretch texturing process. The texturing can thereby be carried out at speeds of greater than 450 m/min.

Because of the high uniformity of the preoriented polyester filaments obtained through the process of the invention, it is possible to obtain a good bobbin shape simply, which makes possible uniform and nearly error-free dyeability, as well as a further processing of the preoriented polyester filaments.

Stretch textured filaments of the invention have high tenacity at break (>26 cN/tex) as well as high elongation at break, >30% for HE filaments and >36% for SET filaments.

The present invention comprises a process of producing and spooling preoriented polyester filaments that comprise polybutylene terephthalate (PBT) and/or polytrimethylene terephthalate (PTMT) in an amount of at least by 90 weight % in relation to the total weight of the polyester filament. Polybutylene terephthalate (PBT) and polytrimethylene terephthalate (PTMT) are known in the art. Polybutylene terephthalate (PBT) can be obtained by polycondensation of terephthalic acid with equimolar quantities of 1,4-butanediol, and polytrimethylene terephthalate can be obtained by polycondensation of terephthalic acid with equimolar quantities of 1,3-propanediol. Mixtures of both polyesters are also contemplated for use in the invention. In accordance with the invention, PTMT is preferred.

The polyesters can be both homo- as well as co-polymers. Especially preferred as copolymers are those that contain, in addition to recurring PTMT and/or PBT units, an additional amount of up to 15 mol. %, in relation to all monomer units of the polyester, monomers of normal polyester comonomers, such as ethylene glycol, diethylene glycol, triethylene glycol, 1,4-cyclohexanedimethanol, polyethylene glycol, isopthalic acid, and/or adipinic acid, for example. Within the framework of the present invention, however, polyester homopolymers are preferred.

Polyesters in accordance with the invention can contain normal quantities of additional additive substances as admixtures, such as catalysts, stabilizers, antistatic agents, antioxidants, flame retarding agents, colorants, colorant absorption modifiers, light stabilizers, organic phosphites, optical brighteners, and matting agents. The polyesters preferably contain from 0 to 5 weight % of additives, in relation to the total weight of the filament.

Furthermore, polyesters of the invention can also contain a slight portion of branching components, preferably up to 0.5 weight % in relation to the total weight of the filament. The branching components include, among others, polyfunctional acids, such as trimellitic acid, pyromellitic acid, or tri- to hexavalent alcohols, such as trimethylolpropane, pentaerythrite, dipentaerythrite, glycerin, or corresponding hydroxy acids.

In the framework of the present invention, 0.05 weight % to 2.5 weight % of additive polymers (relative to the total weight of the filament), are mixed into the PBT and/or PTMT as filament elongation-enhancing agents. Additive polymers that are particularly suitable in accordance with the invention include the polymers and/or copolymers chosen from among the following:

1. A copolymer comprising the following monomer units:

A=acrylic acid, methacrylic acid, or CH₂═CR—COOR′, whereby R is —H or a —CH₃ group, and R′ is a C₁₋₁₅alkyl radical or a C₅₋₁₂ cycloalkyl radical or a C₆₋₁₄ aryl radical;

B=styrol or C₁₋₃-alkyl-substituted styrols;

wherein the copolymer consists of 60 to 98 weight % of A and 2 to 40 weight % of B, preferably 83 to 98 weight % of A and 2 to 17 weight % of B and, particularly preferably, from 90 to 98 weight % of A and 2 to 10 weight % of B (total 100 weight %);

2. A copolymer comprising the following monomer units:

C=styrol or C₁₋₃-alkyl-substituted styrols;

D=one or more monomers of Formula I, II, or III:

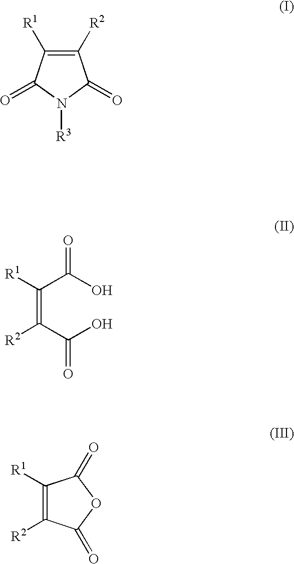

wherein R¹, R², and R³ are each independently —H, a C₁₋₁₅-alkyl radical, a C₆₋₁₄-aryl radical, or a C₅₋₁₂ cycloalkyl radical; and

wherein the copolymer comprises from 15 to 95 weight % of C and from 2 to 80 weight % of D, preferably from 50 to 90 weight % of C and from 10 to 50 weight % of D, and, particularly preferably, from 70 to 85% of C and from 15 to 30 weight % of D, whereby the total of C and D together is 100 weight %;

3. A copolymer comprising the following monomer units:

E=Acrylic acid, methacrylic acid, or CH₂═CR—COOR′, whereby R is an H atom or a CH₃ group and R′ is a C₁₋₅-alkyl radical or a C₅₋₁₂-cycloalkyl radical or a C₆₋₁₄-aryl radical;

F=Styrol or C₁₋₃-alkyl-substituted styrols;

G=One or more monomers of the formulas I, II, or III:

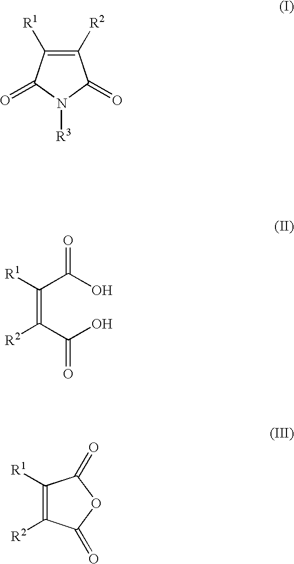

wherein R¹, R², and R³ are each one H atom or a C₁₋₁₅-alkyl radical or a C₆₋₁₄-aryl radical or a C₅₋₁₂-cycloalkyl radical;

H=one or more ethylenic unsaturated monomers, which can be copolymerized with E and/or with F and/or G, from the group which consists of “-methylstyrol, vinylacetate, acrylic acid esters, methacrylic acid esters which are different from E, vinyl chloride, vinylidene chloride, halogen-substituted styrols, vinyl ethers, isopropenyl ethers, and dienes;

wherein the copolymer consists of from 30 to 99 weight % of E, from 0 to 50 weight % of F, from >0 to 50 weight % of G, and from 0 to 50 weight % of H, preferably from 45 to 97 weight % of E, from 0 to 30 weight % of F, from 3 to 40 weight % of G, and from 0 to 30 weight % H and, particularly preferably, from 60 to 94 weight % of E, from 0 to 20 weight % of F, from 6 to 30 weight % of G, and from 0 to 20 weight % of H, whereby the total of E, F, G, and H together yields 100 weight %.

4. A polymer from the following monomer unit:

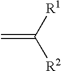

wherein R¹ and R² are substituents consisting of the optional atoms C, H, O, S, P and halogen atoms, and the total of the molecular weight of R¹ and R² is at least 40. Examples of such monomers are: acrylic acid, methacrylic acid, and CH₂═CR—COOR′, whereby R is an H atom or a CH₃ group, and R′ is a C₁₋₁₅ alkyl radical or a C₅₋₁₂-cycloalkyl radical or a C₆₋₁₄-aryl radical, as well as styrol and C₁₋₃-alkyl-substituted styrols.

Specific details for the production of these substances are described in WO 99/07 927.

In the framework of the invention, additive polymers and/or copolymers in the form of bead polymers, the particle size of which lies within a particularly favorable range, are particularly preferred. Preferably, the additive polymers and/or copolymers that are to be used in accordance with the invention, such as by mixing into the melts of the fiber polymers, for example, are present with an average diameter of 0.1 to 1.0 mm. Larger or smaller beads or granulates can also be used, however. The additive polymers and/or copolymers can also be contained in chips of the matrix polymer, so that a measured addition can be dispensed with.

Furthermore, additive polymers and/or copolymers that are amorphous and insoluble in the polyester matrix are preferred. Preferably, they have a glass transition temperature from 90 to 200° C., whereby the glass transition temperature is determined in a known manner, preferably by means of differential scanning calorimetry. Additional details can be derived from the state of the art, such as the publication WO 99/07927, for example.

Preferably, the additive polymer and/or copolymer is selected in such a manner that the ratio of the melt viscosities of the additive polymer and/or copolymer and of the matrix polymer is 0.8:1 to 10:1, preferably from 1.5:1 to 8:1. The melt viscosity is measured, in the known manner, by means of an oscillation rheometer at an oscillation frequency of 2.4 Hz and at a temperature which is equal to the melt temperature of the matrix polymer plus 28° C. For PTMT, the melt viscosity is measured at a temperature of about 255° C. Additional details can, in turn, be derived from the publication WO 99/07927.

The melt viscosity of the additive polymer and/or copolymer is preferably higher than that of the matrix polymer, and it has been shown that the choice of a specific range of viscosity for the additive polymer and/or copolymer, and the choice of the viscosity ratio, contribute to the optimization of the characteristics of the thread that is produced. In one optimized viscosity ratio, one can minimize quantity of additive polymer and/or copolymer added, resulting in a more economical process. The polymer mixture to be spun preferably contains from 0.05 to 2.5 weight %, particularly preferably 0.25 to 2.0 weight %, of additive polymer and/or copolymer.

Through a favorable choice of viscosity ratio, a narrow distribution of additive polymer and/or copolymer particle sizes in the polymer matrix is achieved with the desired fibril structure of the additive polymer and/or copolymer in the thread. The glass transition temperature of the additive polymer and/or copolymer, which is high in comparison with the matrix polymer, ensures a rapid solidification of this fibril structure in the spinning thread. The maximum particle sizes of the additive polymer and/or copolymer, immediately after exiting from the spinning nozzle, are approximately 1000 nm, while the average particle size is 400 nm or less. After the spinline extension, the favorable fibril structure (containing at least 60 weight % of the additive polymer and/or copolymer in the form of fibrils) is achieved with lengths in the range from 0.5 to 20 μm and diameters in the range from 0.01 to 0.5 μm.

The polyesters that are usable in the invention are, preferably, thermoplastically formable and can be spun and spooled into filaments. Polyesters that have an intrinsic viscosity in the range from 0.70 dl/g to 0.95 dl/g are particularly advantageous.

A polymer melt, for example, can be removed directly from the end reactor of a polycondensation equipment, or else produced from solid polymer chips in a melt extruder.

The spinning additive polymers can be added in to the matrix polymer, in the known manner, by means of measured addition in either molten or solid form, distributed homogenously, and dispersed into fine particles. A device in accordance with DE 100 22 889 can be used advantageously.

In the process of the invention, the melt or mixture of melts of the polyester is pressed into spin packs by means of a spinning pump at constant rotational speed adjusted by known means in such a manner that the desired thread titer is achieved. The melt is then extruded through the nozzle apertures of the spinneret plate of the spin pack assembly into molten filaments.

The melt can be produced in an extruder from polymer chips, for example, whereby it is particularly favorable to dry the chips in advance to a water content of ≦30 ppm, particularly to a water content of ≦15 ppm.

The temperature of the melt, which is designated in a general manner as the spinning temperature and measured in the melt before entering the spinning pump, depends upon the melting point of the polymer or mixture of polymers used. It preferably lies in the range stated in Formula 1:

Tₘ+15° C.≦T_{Sp}≦Tₘ+45° C.; Formula 1

in which:

Tₘ: Melting point of the polyester [° C.];

T_{Sp}: Spinning temperature [° C.].

The specified parameters serve to limit the hydrolytic and/or thermal reduction of the viscosity, which should suitably be as low as possible. Within the framework of the present invention, a reduction of viscosity by less than 0.12 dl/g, particularly by less than 0.08 dl/g, is highly desirable.

The homogeneity of the melt has a direct influence on the properties of the spun filaments. It is thus preferable to use a static mixer with at least one element that is installed after the spinning pump for the homogenization of the melts.

The temperature of the spinneret plate, which is dependent upon the spinning temperature, is controlled by means of so-called associated heating. A heating vessel heated with “Diphyl”, or with additional convection or radiation heaters, for example, may contribute to associated heating. The temperature of the spinneret plates is usually around that of the spinning temperature.

One can increase the temperature of the spinneret plate by the pressure drop in the spin pack assembly. Known derivations, such as, for example, that by K. Riggert, “Progress in the production of polyester tire cord thread” in Chemiefasern [Chemistry fibers], 21, page 379 (1971), describe a temperature increase of approximately 4° C. per 100 bar of pressure drop.

In addition, it is possible to control the spin pack pressure through the application of loose filter media, particularly steel sand with an average grain size of between 0.10 mm and 1.2 mm, preferably between 0.12 mm and 0.75 mm, and/or filters with a pore size of ≦40 μm, which can be produced from metal screens or non wovens.

In addition, pressure drop in the nozzle aperture contributes to the overall pressure. The overall spin pack pressure is preferably set between 80 bar and 450 bar, particularly between 100 bar and 250 bar.

The spinline extension ratio i_{Sp}—that is to say, the quotient of the draw-off speed and the capillary extrusion speed—is computed, in accordance with U.S. Pat. No. 5,250,245 by means of Formula 2, with the density of the polymer or mixture of polymers, the diameter of the nozzle aperture, and the titer of the individual filament:

i_{Sp}=2.25·10⁵·(δ·π)·D²(cm)/dpf(den); Formula 2

in which:

δ: Density of the melt [g/cm³]; for PTMT 1.12 g/cm³;

D: Diameter of the nozzle aperture [cm];

dpf: Titer of the individual filament [den].

Within the framework of the present invention, the spinline extension ratio is between 70 and 500, preferably between 100 and 250.

The length/diameter ratio of the nozzle aperture is preferably between 1.5 and 6, especially between 1.5 and 4.

The extruded filaments pass through a cooling delay zone. This is configured as a recess zone directly below the spin pack assembly, inside of which the filaments exiting from the nozzle apertures are protected against the direct effect of cooling gas and are delayed for drawing-off or for cooling. An active portion of the quench delay is provided in the form of an off-set of the spin pack assembly into the spinning heating vessel (beam), so that the filaments are surrounded by heated partitions. A passive portions is formed of insulation layers and unheated framework. The length of the active recess lie between 0 to 100 mm and those of the passive portion lie between 20 to 120 mm, whereby a total length of 30 to 200 mm, preferably 30 to 120 mm, is set.

As an alternative to an active recess, a heated tube can be attached below the spinning beam. In contrast to the active recess, this zone with cylindrical or rectangular cross-section then has heating that is independent of the spinning beam heating.

In radial porous cooling systems concentrically surrounding the thread, cooling delay can be achieved with the help of cylindrical coverings.

The filaments are subsequently cooled to temperatures below their solidification temperature. In accordance with the invention, “solidification temperature” means that temperature at which the melt makes a transition to a solid aggregate.

In the framework of the present invention, it has proven to be particularly suitable to cool the filaments to a temperature at which they are essentially no longer sticky. Cooling of the filaments to temperatures below their crystallization temperature, particularly to temperatures below their glass transition temperature, is particularly advantageous.

Means for cooling the filaments are known in the art. In accordance with the invention, the use of cool gases, particularly cooled air, have proven particularly valuable. The cooling air preferably is from 12° C. to 35° C., particularly from 16° C. to 26° C. The speed of the cooling air advantageously lies within the range from 0.20 m/sec to 0.55 m/sec.

Individual thread systems, which consist of individual cooling tubes with a perforated partition wall, for example, can be used for cooling the filaments. Cooling each individual filament is achieved by means of actively supplying cooling air, or also by using the self-suctioning effect of the filaments. As an alternative to individual tubes, known systems that involve cross-flow quenching can also be used.

One particular configuration of the cooling and extension area consists of supplying the filaments exiting from the quench delay zone with cooling air in a zone with a length in the range from 10 to 175 cm, preferably in a zone with a length in the range of 10 to 80 cm. For filaments with a titer upon spooling of ≦1.5 dtex per filament, zone length in the range of from 10 to 40 cm is suitable, and a length of zone in the range from 20 to 80 cm is particularly well suited for filaments with a titer between 1.5 and 9.0 dtex per filament. Subsequently, the filaments and the air accompanying them are guided in common through a tube of reduced cross-section, whereby the ratio of the air speed to the thread speed of 0.2 to 20:1, preferably 0.4 to 5:1, is set during the drawing-off by controlling the cross-sectional reduction and dimension of the tube in the direction of the running thread.

After cooling the filaments to temperatures below the solidification temperature, they are bundled into a thread. The distance of the bundling from the lower side of the spinneret plate suitable for use in the invention can be determined by methods known in the art for on-line measurement of thread speed and/or temperature, such as, for example, by means of a laser/doppler anemometer from firm TSI/Germany, or an infrared camera from the manufacturer Goratec/Germany, type IRRIS 160. This is 500 to 2500 mm, preferably 500 to 1800 mm. Filaments with a titer of ≦3.5 dtex are thereby preferably bundled at a small distance of ≦1500 mm, while thicker filaments are preferably bundled at a greater distance.

In the framework of the present invention, it is suitable that all surfaces that come into contact with the spun filament are preferably low-friction materials. Formation of broken filaments can be thoroughly avoided in this way, so that higher-valued threads are obtained. Low-friction surfaces, such as “TriboFil” from the firm Ceramtec/Germany, have proven themselves to be particularly well suited for this purpose.

Bundling of the filaments is carried out in an oiling unit that supplies the desired quantity of spinning preparation to the thread. One particularly suitable oiling unit is characterized by an intake part, a thread channel with an oil entrance aperture, and a discharge part. The intake part is expanded in a funnel shape, so that contact with the filaments, which are still dry, is prevented. The contacting point of the filaments lies inside the thread channel behind the inflow feed of the preparation. The thread channel and oil inlet aperture are adjusted in width to the thread titer and the number of filaments. Apertures and widths in the range of 1.0 mm to 4.0 mm have proven particularly valuable. The discharge part of the oiling device is designed as a blending segment, which preferably has oil reservoirs. Such types of oiling devices are commercially available and can be purchased from the firm Ceramtec/Germany, or Goulston/USA, for example.

Uniformity application of oil can be of great importance in the process of the invention. Uniformity can be determined, for example, by means of a Rossa measuring device as described in the journal “Chemiefasern/Textilindustrie” [Chemical Fibers/Textile Industry], 42/94, November 1992, on page 896. Preferably, in such a process, values for the standard deviation of the oil application of <90 units, and preferably <60 units, are obtained. Values for the standard deviation of the oil application of <45 digits, particularly of <30 digits, are particularly preferred in accordance with the invention. A standard deviation of 90 units or 45 units, respectively, corresponds to approximately 6.2% or 3.1%, respectively, of the coefficient of variation.

In the framework of the present invention, it has proven to be particularly advantageous to design spin-finish lines and pumps for the prevention of gas bubbles in a self-degassing manner, since these can lead to a considerable oscillation of the oil application.

In accordance with the invention, entangling of the filaments before spooling the thread is particularly preferred. In this, nozzles with closed thread channels have proven to be particularly well suited, since hooking of the thread in the insertion slot are avoided in such systems, even with low thread tension and high air pressure. The entangling nozzles are preferably positioned between galettes, whereby the thread discharge tension is regulated by means of different speeds of the intake and discharge galette. These should not exceed 0.20 cN/dtex, but primarily have values between 0.05 cN/dtex and 0.15 cN/dtex. The pressure of the entangling air thereby lies between 0.5 and 5.5 bar at spooling speeds up to 3500 m/min. at a maximum of 3.0 bar.

Preferably, node numbers of at least 10 n/m are set. In this, maximum aperture lengths of less than 100 cm and values of the variation coefficients of the node number of below 100% are of particular interest. Upon the use of air pressures above 1.0 bar, node numbers of [symbol] 15 n/m, which are characterized by a high uniformity, are advantageously achieved, whereby the coefficient of variation is less than or equal to 70%, and the maximum length of aperture is 50 cm. In actual practice, systems of the type LD from the firm Temco/Germany, the double system from the firm Slack & Parr/USA, or nozzles of the type Polyjet from the firm Heberlein, have proven to be particularly well suited.

The circumferential speed of the first galette is termed the draw-off speed. Additional galette systems can be applied before the thread is spooled on tubes to form the bobbins within the winder unit.

Stable, error-free bobbins are essential for an error-free removal of the thread, as well as for a further processing that is as free of errors as possible. Thus, in the framework of the present process, a spooling tension of the thread in the range from 0.025 cN/dtex to 0.15 cN/dtex, preferably in the range of 0.03 cN/dtex to 0.08 cN/dtex, is applied.

One important parameter of the process in accordance with the invention is the adjustment of the tension of the thread in front of and between the draw-off galettes. This tension, as is known in the art, essentially composed of the actual orientation tension in accordance with Hamana, the frictional stress on the thread guides and the oiling device, and the thread/air friction stress. Within the framework of the present invention, the tension of the thread in front of and between the draw-off galettes is in the range from 0.05 cN/dtex to 0.20 cN/dtex, preferably between 0.08 cN/dtex and 0.15 cN/dtex.

Insufficient tension (<0.05 cN/dtex) fails to yield the desired level of preorientation. If the tension exceeds 0.20 cN/dtex, it triggers a memory effect upon spooling and storage of the spools, which leads to the worsening of the thread's properties.

In accordance with the invention, the tension is controlled through the distance of the oiling device from the spinneret plate, and the friction surfaces, and the distance between the oiling device and the first draw-off galette. This distance advantageously is not more than 6.0 m, preferably less than 2.0 m, whereby the spinning machine and the draw-off machine are positioned, by means of parallel construction, in such a manner that a straight course of the threads is guaranteed.

The conditioning time of the thread between the bundling point and the spooling are described by means of the geometrical parameters. The relaxation that is proceeding rapidly during this time influences the quality of the bobbin shape.

The conditioning time, as defined in such manner, is preferably selected between 50 and 200 ms.

In accordance with the invention, the spooling speed of the POY's is between 2200 m/min. and 6000 m/min. A speed of between 2500 m/min. and 6000 m/min. is preferably chosen. Particularly preferably, the polymer mixtures are spooled at speeds in the range from 3500 m/min. to 6000 m/min.

In an advantageous manner, the temperature in the vicinity of the bobbins is set to <45° C., particularly between 12 and 35° C., and the relative humidity is set to 40 to 85%. Furthermore, it is suitable to store the POY spools for at least 4 hours at 12 to 35° C. and a relative humidity of 40 to 85% before further processing.

After 4 weeks of storage under normal conditions, the filament in accordance with the invention has:

a) an elongation at break of between 90 and 165%, preferably between 90 and 135%;

b) a boiling water shrinkage of at least 30%, preferably ≧40%;

c) a normal uster below 1.1%, preferably less than 0.9%;

d) a birefringence of between 0.030 and 0.058;

e) a density of less than 1.35 g/cm³, preferably less than 1.33 g/cm³;

f) a coefficient of variation of the tensile strength at break of ≦4.5%, preferably ≦2.5%; and

g) a coefficient of variation of the elongation at break of ≦4.5%, preferably ≦2.5%.

The term “normal conditions” is known in the art and is defined by the norm DIN 53802. At “normal conditions” in accordance with DIN 53802, the temperature is 20±2° C. and the relative humidity 65±2%.

In the framework of the present invention, it is additionally advantageous that the boiling-water shrinkage when measured immediately after the spooling is between 50 and 65% and, after 4 weeks of storage at normal conditions, at least 30%, preferably ≧40%. It has been surprisingly shown that POY bobbins produced in such a manner can be further processed in an outstanding manner.

Processes for the determination of the material properties are best known to those skilled in the art. They can be found in the technical literature. Although most parameters can be determined in a variety of ways, the following methods have, within the framework of the present invention, proven to be particularly suitable for the determination of the characteristic values of the filament.

The intrinsic viscosity is measured at 25° C. in the capillary viscosimeter from the firm Ubbelohde and computed in accordance with a known formula. A mixture of phenol/1.2-dichlorobenzol is used as a solvent in the weight ratio of 3:2. The concentration of the solution is 0.5 g polyester to 100 ml of solution.

A DSC calorimeter from the firm Mettler is used to determine the melting point and the temperature of crystallization and glass transition. In this, the sample is thereby first heated to 280° C. and melted, and then suddenly chilled. The DSC measurement is carried out in the range from 20° C. to 280° C., with a heating rate of 10 K/min. The temperature is determined by the processor.

The density of the filaments is determined in a density/gradient column at a temperature of 23±0.1° C. n-heptane (C₇H₁₆) and tetrachloromethane (CCl₄) are used as the reagent. The result of the density measurement can be used to compute the degree of crystallization, since the density of the amorphous polyester Dₐ and the density of the crystalline polyester Dₖ are taken as the basis. The corresponding computation is known in the art; for example, the following is valid for PTMT: Dₐ=1.295 g/cm³ and Dₖ=1.429 g/cm³.

The titer is determined in the known manner by means of a precision reeling machine and a weighing device. The pre-stressing is suitably 0.05 cN/dtex for preoriented filaments (POY's), and to 0.2 cN/dtex for textured thread (DTY).

The tenacity at break and the elongation at break are determined in a Statimat tensile tester with the following conditions: the clamping length is 200 mm for POY or 500 mm for DTY; the measuring speed is 2000 mm/min. for POY or 1500 mm/min. for DTY; and the pre-stressing is 0.05 cN/dtex for POY or 0.2 cN/dtex for DTY. Tenacity at break is determined by dividing the values of the maximum tensile strength by the titer, while the elongation at break is evaluated at the maximum strength.

To determine the boiling-water shrinkage, strands of threads are treated, in a tension-free manner, in water at 95±1° C. for 10±1 min. The strands are produced by means of a reeling machine with pre-stressing of 0.05 cN/dtex for POY or of 0.2 cN/dtex for DTY; the measurement of the length of the strands before and after the temperature treatment is conducted at 0.2 cN/dtex. The boiling-water shrinkage is computed in the known manner from the differences in lengths.

The determination of the birefringence is carried out in accordance with the procedure described in DE 19 519 898.

The characteristic bulk values of the textured threads are measured, in accordance with DIN 53840, Part 1, by means of the Texturmat device from the firm Stein/Germany, at the development temperature of 120° C.

The normal uster values are determined with the 4-CX Uster Tester and stated as uster % values. At a test speed of 100 m/min., the test time for this is 2.5 min.

The POY in accordance with the invention can be further processed simply and can, in particular, be stretch-textured. Within the framework of the present invention, the stretch texturing is preferably carried out at a texturing speed of at least 500 m/min. and particularly preferably at a texturing speed of at least 700 m/min. The stretching ratio is preferably at least 1:1.35, and particularly at least 1:1.40. Stretch texturing on a machine of the high-temperature heater type, such as the AFK from the firm Barmag, for example, has proven to be particularly suitable.

Bulky threads produced in such a manner have a low number of broken filaments and, depending on the dyeing under processing conditions with a carrier-free dispersion colorant, have both an excellent depth of color and a uniformity of color.

Bulky SET filaments produced in accordance with the invention preferably have a tenacity at break of more than 26 cN/tex and an elongation at break of more than 36%. In bulky HE filaments, which can be obtained without temperature application in a second heater, the tenacity at break preferably is >26 cN/tex, and the elongation at break is >30%.

The bulkiness and elasticity behavior of the filaments in accordance with the invention is outstanding.

The invention will be illustrated in the following by means of examples, without the invention having to be restricted to these examples.

### EXAMPLES 1 TO 3

### Spinning and spooling

PTMT chips with an intrinsic viscosity of 0.93 dl/g, a melt viscosity of 325 Pa s (measured at 2.4 Hz and 255° C.), a melting point of 227° C., a crystallization temperature of 72° C., and a glass transition temperature of 45° C., were dried in a tumble dryer at a temperature of 130° C. to a water content of 11 ppm.

The chips were melted in a 3E4 extruder from the firm Barmag, so that the temperature of the melt was 255° C. Different quantities of polymethylmethacrylate of the commercial type Plexiglas 7N from the firm Röhm GmbH/Germany, which had previously been dried to a residual moisture of less than 0.1%, were added into this melt as a filament elongation-enhancing additive.

The additive polymer was, in addition, melted by means of a melt extruder and supplied to the feeding device by means of a toothed wheel dosing pump and supplied there in the direction of flow with the polyester component by means of an injection nozzle. In a static mixer from the firm Sulzer, type SMX, having 15 elements and an internal diameter of 15 mm, both of the melts were homogenously mixed with one another and finely dispersed.

The melt viscosity of the type Plexiglas 7N was 810 Pa s (2.4 Hz, 255° C.), whereby the ratio of the additive- and polyester melt viscosity was 2.5:1.

63 g/min. of melt was transported with a residence time of 6 min., and the quantity fed into the spin pack by means of the spinning pump was set in such a manner that the POY titer was approximately 102 dtex. Different spooling speeds were set. An element of a static mixer, type HD-CSE from the firm Fluitec with an internal diameter of 10 mm, was installed after the spinning pump and before the entrance into the spin pack. The associated heating units of the product line and spinning beam, which contained the pump and the spin pack assembly, were set at 255° C. The spin pack contained the filter media steel sand of the grain size 350 to 500 μm at a level of 30 mm, as well as a 20 μm non-woven filter and a 40 μm screen filter. The melt was extruded through a spinning plate 80 mm in diameter with 34 holes 0.25 mm in diameter and a length of 1.0 mm. The spin pack pressure was approximately 120 to 140 bar.

The cooling delay zone had a length of 100 mm, whereby 30 mm were a heated partition wall, and 70 mm were insulation and unheated framework. Subsequently, the melt threads were cooled off in a quench duct with a cross-flow current blowing with a blowing length of 1500 mm. The cooling air had a speed of 0.35 m/sec., a temperature of 18° C., and a relative humidity of 80%. The solidification point of the filaments lay at a distance approximately 800 mm below the spinning plate.

The threads were provided with spinning preparation and bundled with the help of a thread oiling device at a distance of 1050 mm from the spinneret plate. The oiling device had a TriboFil surface and a channel width of 1 mm in diameter. The quantity of preparation applied was 0.40% in relation to the weight of the thread.

The bundled thread was then conveyed to the spooling machine. The distance between the oiling device and the first draw-off galette was 3.2 m. The conditioning time was between 105 and 140 ms. The pair of galettes was looped around by the thread in an S-shaped manner. A Temco entangling nozzle, which was operated at an air pressure of 1.5 bar, was installed between the galettes. Corresponding to the adjustment of the speed, the spooling speed of the winding device of the type SW6 from the firm Barmag was set in such a manner that the spooling tension of the thread was 5 cN. The room climate was set at 24° C. at 60% relative humidity, so that a temperature of approximately 34° C. was set in the vicinity of the thread bobbin.

A significant increase of the productivity was achieved for all of the quantities of additives that were mixed in. Ten kg spools, which could be removed from the spool chuck without any problem, were produced. The POY threads were distinguished by a good temporal consistency of the thread characteristics over the storage time of 4 weeks at a normal climate in accordance with DIN 53802. Immediately after the spinning and spooling, the boiling-water shrinkage was determined to be within the range of 51 to 54%. The processability in texturing and uniformity of dyeability were outstanding. The stretching ratio applied was surprisingly high for the POY speeds that were used.

The additional parameters and characteristic values are summarized in Tables 1 to 4.

TABLE 1
Experimental parameters

| Experimental parameters | | Example 1 | Example 2 | Example 3 |
|---|---|---|---|---|
| Concentration of additive | [%] | 0.5 | 0.7 | 1.0 |
| Draw-off speed | [m/min] | 3011 | 3520 | 4022 |
| Spooling speed | [m/min] | 3005 | 3500 | 4000 |
| Spinline extension ratio | | 183 | 182 | 181 |
| Thread tensions- | | | | |
| In front of galettes (1) | [cN] | 13 | 15.5 | 16 |
| Between galettes (1)- | [cN] | 12 | 13 | 12.5 |
| max. | | | | |
| In front of galettes (2) | [cN/dtex] | 0.13 | 0.15 | 0.16 |
| Between galettes (2)- | [cN/dtex] | 0.11 | 0.13 | 0.12 |
| max. | | | | |
| Spooling tension of the | [cN] | 6.3 | 5.9 | 6.4 |
| thread (1) | | | | |
| Spooling tension of the | [cN/dtex] | 0.062 | 0.058 | 0.062 |
| thread (2) | | | | |

(1) Absolute.
(2) In relation to the titer.

TABLE 2
Materials characteristics of the preoriented PTMT filaments (1).

| Materials characteristics: | | Example 1 | Example 2 | Example 3 |
|---|---|---|---|---|
| Titer | [dtex] | 102 | 102.5 | 103 |
| Tenacity at break | [cN/tex] | 20.2 | 21.8 | 22.3 |
| Elongation at break | [%] | 132.7 | 115.4 | 98.2 |
| Normal uster | [%] | 0.80 | 0.90 | 0.94 |
| Boiling-water shrinkage | [%] | 48 | 44 | 38 |
| Birefringence · 10³ | Δn | 36 | 47 | 51 |
| Density | g/cm³ | 1.315 | 1.318 | 1.320 |
| CV-maximum tensile | [%] | 1.7 | 1.5 | 2.1 |
| strength | | | | |
| CV-elongation at break | [%] | 1.9 | 1.9 | 3.3 |

CV: Coefficient of variation.
(1): Measured after 4 weeks of storage at normal conditions.

### Stretch Texturing

The PTMT filament bobbins were stored in normal climate for four weeks in accordance with DIN 53802 and then submitted to a stretch texturing machine from the firm Barmag, type FK6-S-900. The test parameters of the stretch texturing for the production of so-called SET filaments are summarized in Table 3, while the materials characteristics of the resulting bulky SET filaments are summarized in Table 4.

The texturing errors were determined by means of the UNITENS from the firm Barmag, with the following adjustments of range finding data:

UP/LP=3.0 cN;

UM/LM=6.0 cN.

TABLE 3
Test parameters of the stretch texturing

| Experimental | | | | |
|---|---|---|---|---|
| parameters | | Example 1 | Example 2 | Example 3 |
| Speed | [m/min.] | 700 | 700 | 700 |
| Stretching ratio | | 1:1.70 | 1:1.60 | 1:1.44 |
| D/Y ratio | | 2.1 | 2.1 | 2.1 |
| Temp[erature]- | [° C.] | 155 | 155 | 155 |
| Heater 1 | | | | |
| Temp[erature]- | [° C.] | 160 | 160 | 160 |
| Heater 2 | | | | |
| Texturing errors | [n/10 km] | 0 | 0 | 0 |
| Tension of the thread | | | | |
| F1, in front of false- | [cN] | 17 | 18 | 19 |
| twist unit | | | | |
| F², behind the false- | [cN] | 19 | 21 | 21 |
| twist unit | | | | |
| F²-CV | [%] | 0.78 | 0.93 | 0.89 |

F²-CV: Coefficient of variation of F².

TABLE 4
Materials characteristics of the stretch-textured filaments

| Materials characteristics | | Example 1 | Example 2 | Example 3 |
|---|---|---|---|---|
| Titer | [dtex] | 67 | 69 | 79 |
| Tenacity at break | [cN/tex] | 26.9 | 29.6 | 28.2 |
| Elongation at break | [%] | 38.6 | 37.8 | 38.0 |
| Visual dyeability evaluation | | Uniform | Uniform | Uniform |
| Bulk stability | [%] | 84 | 85 | 79 |
| Bulkiness | [%] | 25 | 24 | 23 |

We claim:

1. In a process for producing and spooling preoriented polyester filaments that comprise at least 90 weight % (relative to the total weight of the polyester filaments) polybutylene terephthalate (PBT) and/or polytrimethylene terephthalate (PTMT), the improvement comprising
(a) mixing the polyester comprising the PBT and/or PTMT with from 0.05 weight % to 2.5 weight % (relative to the total weight of the filament) of a filament elongation-enhancing agent;
(b) spinning the polyester produced in (a) into filaments through spinning nozzles with a spinline extension-ratio in the range of 70 to 500;
(c) passing the filaments through a cooling delay zone of from 30 mm to 200 mm in length immediately after exiting from the spinning nozzles;
(d) cooling the filaments to below the PBT or PTMT solidification temperature;
(e) bundling the filaments into thread at a distance of between 500 mm and 2500 mm from the spinneret plate;
(f) setting the thread tension in front of and between draw-off galettes to between 0.05 cN/dtex to 0.20 cN/dtex;
(g) spooling the thread with a thread tension of between 0.025 cN/dtex to 0.15 cN/dtex and a spooling speed between 2200 m/min. and 6000 m/min.

2. The process according to claim 1, wherein the PBT and/or PTMT are used with an intrinsic viscosity in the range from 0.7 dl/g to 0.95 dl/g.

3. The process according to claim 1, wherein the temperature in the vicinity of the thread bobbin during the spooling is ≦45° C.

4. The process according to claim 1, further comprising storing the POY bobbins for at least 4 hours at 12 to 35° C. and at 40 to 85% relative humidity before further processing.

5. The process according to claim 1, wherein the spooling speed is set between 2500 m/min. and 6000 m/min.

6. Preoriented polyester filaments wherein after 4 weeks of storage under normal conditions in accordance with DIN 53802, the filaments have the following properties:
a) an elongation at break between 90 and 165%;
b) a boiling-water shrinkage of at least 30%;
c) a normal uster below 1.1%;
d) a birefringence between 0.030 and 0.058;
e) a density less than 1.35 g/cm³;
f) a coefficient of variation of the maximum tensile strength of ≦4.5%; and
g) a coefficient of variation of the elongation at break of ≦4.5%.

7. A process for the production of bulky polyester filaments, the process comprising processing the filaments according to claim 6 into bulky threads in a stretch texturing machine at a speed of at least 500 m/min. and a stretching ratio of at least 1:1.35.

8. Bulky polyester SET filaments having a tenacity at break of more than 26 cN/tex and an elongation at break of more than 36%.

9. Bulky polyester HE filaments having tenacity at break of more than 26 cN/tex and elongation at break of more than 30%.

10. Bulky polyester SET filaments made according to the process of claim 7.

11. Bulky polyester HE filaments made according to the process of claim 7.

12. The process according to claim 1, wherein the preoriented polyester filaments comprises at least 90 weight % (relative to the total weight of the polyester filaments) PTMT.

13. The preoriented polyester filaments according to claim 6, the density is less than 1.33 g/cm³.
